(19) United States
(12) Patent Application Publication
(10) Pub. No.: US 2008/0057342 A1
(43) Pub. Date: Mar. 6, 2008

(54) COLOR CONVERSION SUBSTRATE

(75) Inventor: Takashi Sekiya, Sodegaura-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Idemitsu Kosan Co., Ltd., Chiyoda-ku (JP)

(21) Appl. No.: 11/557,282

(22) Filed: Nov. 7, 2006

(30) Foreign Application Priority Data
Sep. 5, 2006 (JP) 2006-239894

(51) Int. Cl. B32B 9/00; B32B 7/00

(52) U.S. Cl. 428/690; 428/917; 313/112; 257/98

(57) ABSTRACT

A color conversion substrate including a color conversion medium including at least inorganic-luminescent-nanocrystal particles; and a color filter having a transmitting band with a width of 70 nm or more where the color filter has a transmittance of 0.5 or more, the color filter being formed on one side of the color conversion medium; the absorbance of the color conversion medium being 0.1 or more and 2 or less at the wavelength of the transmitting band edge on the shorter wavelength side of the color filter where the color filter has a transmittance of 0.5.

### TECHNICAL FIELD

The invention relates to a color conversion substrate. For example, the invention relates to a color conversion substrate which can form an organic electroluminescent color emitting apparatus in combination with an organic electroluminescent device. In particular, the invention relates to a color conversion substrate formed by combining a color conversion medium containing luminescent nanocrystal particles and a color filter having a transmitting band with a width of 70 nm or more where the color filter has a transmittance of 0.5 or more.

### BACKGROUND

A color conversion substrate which converts the wavelength of light emitted from a light source using a fluorescent material has been applied in various fields such as the electronic display field. For example, an organic electroluminescent device (“electroluminescent” may be hereinafter referred to as “EL”) has been disclosed which has an organic electroluminescent material which emits light of blue or bluish green and a fluorescent material part which absorbs light emitted from the emitting layer and emits visible fluorescence of at least one color from bluish green to red (see Patent Document 1, for example).

This method utilizes a blue light source and converts the color of light using a color conversion medium to obtain the three primary colors. Specifically, a fluorescent dye in the color conversion medium is excited by irradiation of blue light, whereby green or red light having a longer wavelength is generated.

Organic fluorescent dyes and organic fluorescent pigments have been generally used as the fluorescent materials for the color conversion medium. For example, a red color conversion medium has been disclosed which is obtained by dispersing a rhodamine fluorescent pigment and a fluorescent pigment having an absorption in the blue region and inducing energy transfer or reabsorption in the rhodamine fluorescent pigment in a light-transmitting medium (see Patent Document 2, for example).

A technique of using a color conversion medium in combination with a color filter has been disclosed as a method of improving the chromatic purity of an EL device having a color conversion medium and improving the contrast ratio in the presence of external light (Patent Document 3).

In order to improve green emitting performance, use of a color filter containing a phthalocyanine dye and having a peak wavelength of transmittance in the range from 490 to 530 nm has been proposed (Patent Document 4).

In order to improve chromatic purity, a technique has been disclosed in which the absorbance is 1 or more at a wavelength of 450 to 500 nm and is 0.1 or more at a wavelength of 550 to 650 nm (Patent Document 5).

The above Patent Documents 1 to 5 disclose techniques using an organic fluorescent dye or pigment as the fluorescent conversion material.

These techniques encounter a problem that the conversion efficiency is limited due to concentration quenching or the conversion performance deteriorates due to thermal/chemical reactions during the production process. Moreover, since the emission spectrum of an organic fluorescent material has a broad emission band, it is necessary to block part of the fluorescence using a color filter having a narrow band in order to improve chromatic purity. As a result, fluorescent energy is wasted, whereby the device exhibits a lowered efficiency.

In order to solve the above-mentioned problems, Patent Document 6 proposes a technique of forming a full-color organic EL device utilizing an inorganic nanocrystal. According to this technique, a film obtained by dispersing CdS, CdSe, or CdTe as the inorganic nanocrystal in a light-transmitting resin is used as a color conversion medium and combined with an organic EL device emitting blue light having a peak wavelength of 450 nm, thereby obtaining red light and green light. The colors obtained by conversion such as red and green are controlled by adjusting the particle size of the inorganic nanocrystal.

Patent Document 7 discloses a color emitting apparatus exhibiting high fluorescence conversion efficiency and excellent durability which is obtained by combining an organic EL light source and a color conversion medium in which inorganic nanocrystal particles are dispersed. This technique utilizes the high refractive index of the inorganic nanocrystal to optimize the design of the color conversion medium to maximize the conversion efficiency.

The techniques disclosed in the Patent Documents 6 and 7 eliminate the problems such as limitations of conversion efficiency due to concentration quenching and a deterioration in conversion performance due to thermal/chemical reactions during the production process. However, when using an inorganic nanocrystal, in particular, a semiconductor nanocrystal, the contrast ratio is lowered even though a color filter is used in combination. Specifically, since the inorganic nanocrystal has a strong absorption and excitation in the vicinity of the emission peak wavelength, fluorescence occurs due to excitation of the inorganic nanocrystal caused by external light transmitted through the color filter.
[Patent Document 1] JP-A-3-152897
[Patent Document 2] JP-A-8-286033
[Patent Document 3] Japanese Patent No. 2838064
[Patent Document 4] JP-A-2000-3786
[Patent Document 5] JP-A-2001-52866
[Patent Document 6] U.S. Pat. No. 6,608,439
[Patent Document 7] WO 2005/097939

The invention has been achieved in view of the above-described problems. An object of the invention is to provide a color conversion substrate using an inorganic nanocrystal and exhibiting an improved contrast ratio in the presence of external light.

1. A color conversion substrate comprising:

a color conversion medium comprising at least inorganic-luminescent-nanocrystal particles; and

a color filter having a transmitting band with a width of 70 nm or more where the color filter has a transmittance of 0.5 or more, the color filter being formed on one side of the color conversion medium;

the absorbance of the color conversion medium being 0.1 or more and 2 or less at the wavelength of the transmitting band edge on the shorter wavelength side of the color filter where the color filter has a transmittance of 0.5.

2. The color conversion substrate according to 1 wherein the color conversion medium comprises a transparent medium and the inorganic-luminescent-nanocrystal particles dispersed in the transparent medium.

3. The color conversion substrate according to 1 or 2 wherein the inorganic-luminescent-nanocrystal particles are a semiconductor nanocrystal.

4. The color conversion substrate according to any one of 1 to 3 wherein the width of the transmitting band of the color filter is 70 nm or more and 120 nm or less.

5. The color conversion substrate according to any one of 1 to 3 wherein the width of the transmitting band of the color filter is 80 nm or more and 110 nm or less.

6. The color conversion substrate according to any one of 1 to 5 that is a green color conversion substrate having an emission peak wavelength in the range from 470 to 550 nm.

7. A color converting substrate wherein at least one color pixel comprises the color conversion substrate of any one of 1 to 6.

According to the invention, a color conversion substrate can be provided which exhibits a high conversion efficiency and achieves a high contrast in the presence of external light. The color conversion substrate of the invention is suited to an organic EL color emitting apparatus. An emitting apparatus using the color conversion substrate of the invention can realize reduced power consumption.

### BRIEF DESCRIPTION OF THE DRAWINGS

FIG. 1 is a schematic cross-sectional view of a color conversion substrate according to a first embodiment of the invention.

FIG. 2 shows the emission spectrum of a fluorescent lamp, the absorbance of a color conversion medium, and the transmittance spectrum of a virtual color filter used for calculation.

FIG. 3 shows the calculated spectrum of reflected light.

FIG. 4 is a view showing the transmitting band of a color filter used for calculation.

FIG. 5 is a graph showing the relationship between the intensity of reflected light, contrast index, and conversion efficiency and the width of the transmitting band of a color filter.

FIG. 6 is a graph showing the relationship between the intensity of reflected light, contrast index, and conversion efficiency and the absorbance of a color conversion medium.

FIG. 7 is a schematic cross-sectional view of a color converting substrate according to a second embodiment of the invention.

FIG. 8 is a schematic cross-sectional view of an organic EL color emitting apparatus formed by combining a color converting substrate and an organic EL device.

FIG. 9 shows the transmittance spectra of color filters CF1 to CF4.

### DETAILED DESCRIPTION OF THE PREFERRED EMBODIMENTS

### First Embodiment

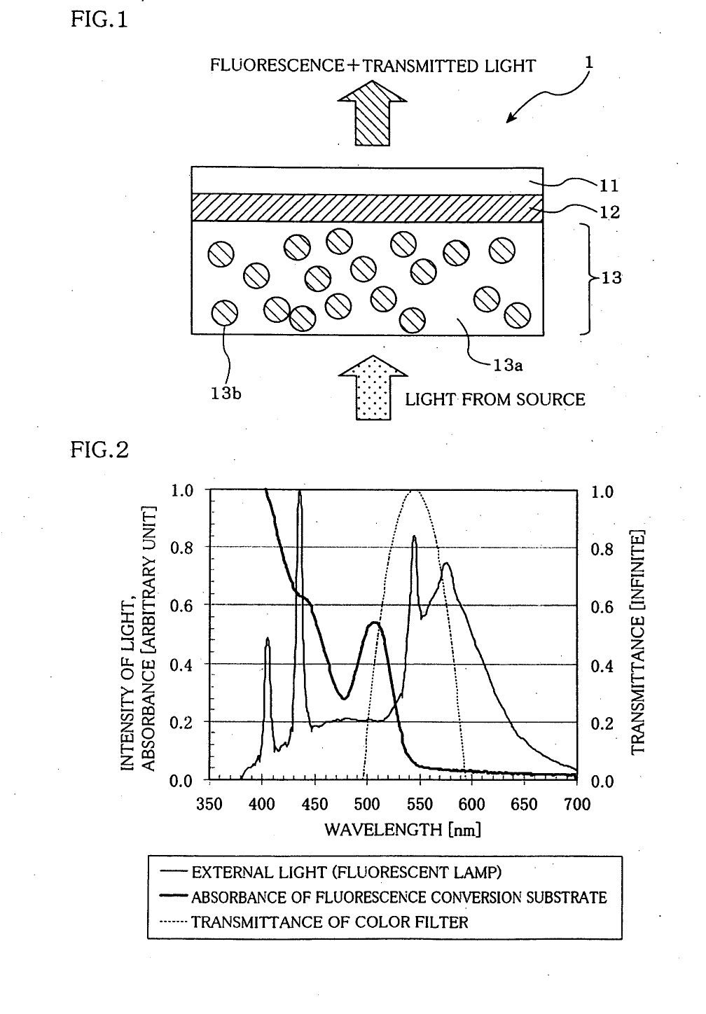

FIG. 1 is a schematic cross-sectional view of a color conversion substrate according to a first embodiment of the invention.

A color conversion substrate 1 has a structure in which a color filter 12 and a color conversion medium 13 are stacked on a substrate 11 in that order.

The substrate 11 supports the color filter 12 and the like. As the substrate 11, a substrate used in the art such as a transparent glass substrate or resin substrate may be used.

The color filter 12 has a function of adjusting the color of emitted light to a desired color. In addition, the color filter 12 suppresses a decrease in contrast ratio (i.e. ratio of brightness when an emitting apparatus emits light and brightness when the emitting apparatus does not emit light) caused by fluorescence generated in the color conversion medium due to light entering from the outside of the emitting apparatus, such as sunlight and interior illumination light, or caused when incident light is reflected by a reflecting electrode and again exits from the apparatus.

The color conversion medium 13 is a film in which luminescent particles 13b are dispersed in a transparent medium 13a. The color conversion medium 13 absorbs excitation light emitted from a light source (not shown), and emits light (fluorescence) having a spectrum differing from that of the light from the light source.

In the invention, the color conversion medium contains luminescent nanocrystal particles, and the color filter has a transmitting band with a width of 70 nm or more where the color filter has a transmittance of 0.5 or more. According to the above configuration, a color conversion substrate can be provided which exhibits a high efficiency, realizes reduced power consumption, and attains a high contrast in the presence of external light.

In the specification, the term “transmitting band” refers to the wavelength range where the color filter has a light transmittance of 0.5 (50%) or, more. The term “width of transmitting band” refers to the width between two wavelengths (edge on the shorter wavelength side and edge on the longer wavelength side) where the color filter has a light transmittance of 0.5. The transmitting band of the color filter is determined by measuring the transmittance of the color filter using an ultraviolet-visible spectrophotometer to determine the wavelength region where the color filter has a transmittance of 0.5 or more.

Generally, a color filter having a narrow transmitting band is used to block external light and improve the contrast ratio. Specifically, a color filter having a transmitting band with a width of about 60 to 70 nm is used. The inventor has found that use of a color filter having a broad transmitting band in combination with a color conversion medium using an inorganic nanocrystal achieves a unique performance.

FIG. 2 shows the emission spectrum of a fluorescent lamp (external light), the absorbance spectrum of the color conversion medium (green CdSe/ZnS core/shell type semiconductor nanocrystal has an emission peak wavelength of 525 nm and an FWHM of 30 nm), and the transmittance spectrum of a virtual color filter (transmittance properties constitute a parabola pattern, and the width of the transmitting band where the color filter has a transmittance of 0.5 or more is 70 nm).

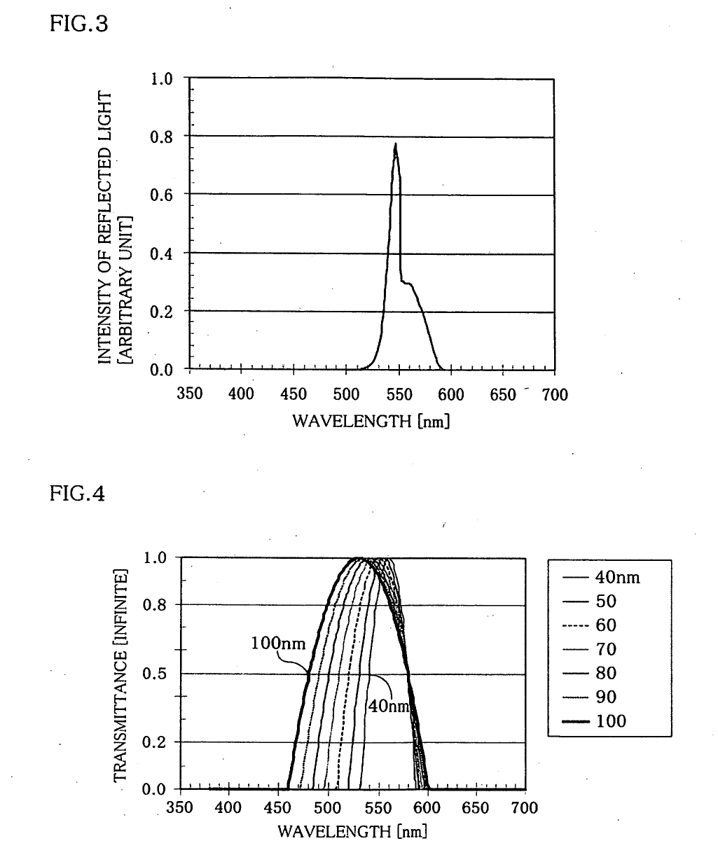

FIG. 3 shows the spectrum of reflected light calculated from the above spectra.

The reflectance of an organic EL device (light source) used in combination with the color conversion substrate is set at 0.8. The spectrum of reflected light is calculated as follows.

External light is filtered through the color filter and is incident on the color conversion medium. The light travels through the color conversion medium towards the light source, while being absorbed by the color conversion medium. The light is reflected by the light source, passes through the color conversion medium while being absorbed again by the color conversion medium, is transmitted through the color filter, and then exits there from. The light absorbed by the light conversion medium is emitted at a longer wavelength side at a specific fluorescence quantum efficiency (assumed to be 0.8). The emitted light travels towards the color filter and the light source while being absorbed by the color conversion medium. The light traveling towards the color filter passes through the color filter and exits therefrom. The light traveling towards the light source reaches the light source while being absorbed by the color conversion medium, is reflected by the light source, passes through the color conversion medium again, passes through the color filter, and exits therefrom. The spectrum of the reflected light was calculated taking the above process into consideration.

The reflected light contains components emitted from the semiconductor nanocrystal in addition to the reflected components of external light passing through the color filter. The unique properties brought about by the use of the inorganic nanocrystal are that the reflected light is suppressed to a large extent on the shorter wavelength side of the transmitting band of the color filter. This is because most of the external light is absorbed by absorption at the absorption edge of the inorganic nanocrystal (maximum absorption at around 500 nm).

FIG. 4 shows the transmitting band of the color filter used for the calculation. The width of the transmitting band was changed from 40 to 100 nm to calculate the performance of the color conversion substrate.

The luminance of reflected light is the luminance of light which exits as a result of external light (sum of reflected light components and components emitted from inorganic nanocrystal: arbitrary unit). The conversion efficiency is the performance of the color conversion substrate estimated on the assumption that a bottom-emission type organic EL device having a peak emission wavelength of 470 nm is used as the light source. The conversion efficiency is the ratio of the luminance of converted light to the luminance of incident light from the organic EL device, and expressed as a percentage. Specifically, the conversion efficiency may be considered to represent the luminance when supplying a specific amount of power. Therefore, since the value obtained by dividing the conversion efficiency by the luminance of reflected light represents a contrast ratio, this value is used as a contrast index (arbitrary unit) after appropriate scaling.

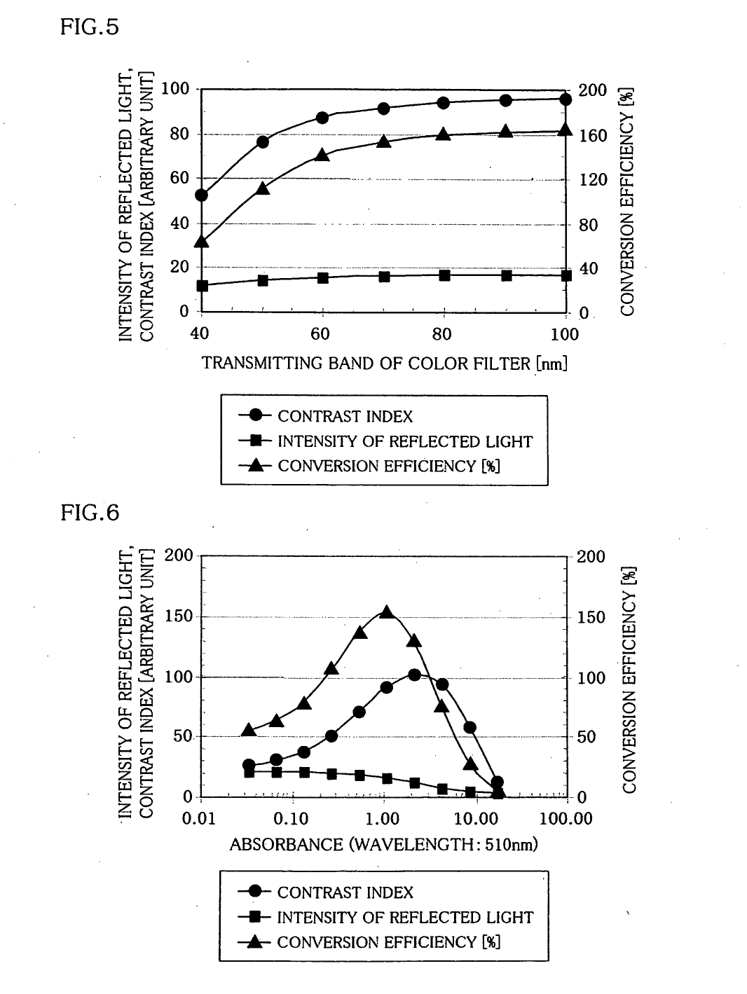

FIG. 5 is a graph showing the relationship between the intensity of reflected light, the contrast index, and the conversion efficiency and the width of the transmitting band of the color filter.

The results shown in FIG. 5, contrary to the anticipated results, indicate that the contrast ratio increases as the width of the transmitting band of the color filter increases. This is because light emitted from the color conversion medium can be outcoupled sufficiently by increasing the width of the transmitting band. In this case, the amount of fluorescent components generated from the color conversion medium due to excitation by external light also increases. Reflection of external light on the shorter wavelength side of the transmitting band is suppressed by the specific absorption of the inorganic nanocrystal. Therefore, an increase in the amount of light outcoupled from the device exceeds an increase in the amount of light emitted, whereby the contrast ratio can be improved.

From the above results, it was confirmed that the width of the transmitting band is preferably 70 nm or more as the region in which a high conversion efficiency of the substrate is achieved while ensuring a high contrast ratio. The width of the transmitting band is more preferably 70 nm or more and 120 nm or less, and particularly preferably 80 nm or more and 110 nm or less.

The color conversion substrate of the invention may particularly preferably be used as a green color conversion substrate having an emission peak wavelength of 470 to 550 nm.

In the invention, the absorbance of the color conversion medium is 0.1 or more and 2 or less at the wavelength of the transmitting band edge of the color filter on the shorter wavelength side where the color filter has a transmittance of 0.5.

As described above, the inorganic nanocrystal is important in the invention. The luminance of reflected light, the conversion efficiency, and the contrast index were calculated for the absorbance at the transmitting band edge of the color filter (510 nm the shorter wavelength side, when using a color filter having a transmitting band with a width of 70 nm) while changing the concentration of the inorganic nanocrystal.

FIG. 6 is a graph showing the relationship between the intensity of reflected light, the contrast index, and the conversion efficiency and the absorbance of the color conversion medium.

As is clear from the graph, it is understood that the absorbance of the color conversion medium is 0.1 to 2, and particularly preferably 0.2 to 2. When the absorbance is less than 0.1, the luminance and the contrast ratio maybe insufficient. An absorbance exceeding 2 means that the concentration of the inorganic nanocrystal is extremely high. In this case, the dispersibility of the inorganic nanocrystal particles in the transparent medium may be decreased.

### Second Embodiment

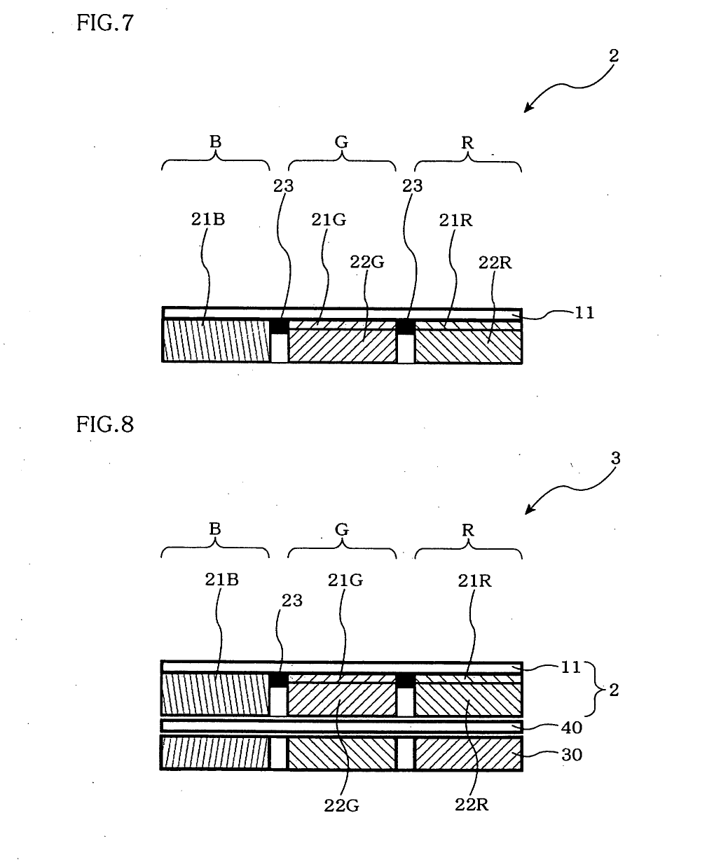

FIG. 7 is a schematic cross-sectional view of a color invention.

A color converting substrate 2 utilizes the color conversion substrate according to the first embodiment. The color converting substrate 2 includes a blue color filter 21B, a multilayer body of a green color filter 21G and a green color conversion medium 22G, and a multilayer body of a red color filter 21R and a red color conversion medium 22R.

In the color converting substrate 2, a blue pixel B is formed by a light source (not shown) and the blue color filter 21B. Similarly, a light source and the multilayer body of the green color filter 21G and the green color conversion medium 22G form a green pixel G, and a light source and the multilayer body of the red color filter 21R and the red color conversion medium 22R form a red pixel R. As shown in FIG. 7, a black matrix 23 may be formed between the pixels.

A full-color display can be achieved by independently driving the light sources corresponding to the respective pixels using a known method.

In this embodiment, the color conversion substrate according to the first embodiment may be suitably used for the green pixel, in particular. The configuration disclosed in the above-mentioned Patent Document 7 may be suitably used for the blue and red pixels, for example.

FIG. 8 is a schematic cross-sectional view of an organic EL color emitting apparatus obtained by combining a color converting substrate and an organic EL device.

An organic EL color emitting apparatus 3 has a configuration in which an organic EL device 30 as a light source and the color converting substrate 2 are stacked through a transparent medium 40.

As the organic EL device, an organic EL device disclosed in the Patent Document 7 or the like may be used.

As the transparent medium, an inorganic material, an organic material, a multilayer body of these materials, or the like may be used insofar as the material is transparent and has a visible light transmittance of 50% or more.

When the transparent medium is formed of an inorganic material, it is preferred that the transparent medium be an inorganic oxide layer, an inorganic nitride layer, or an inorganic acid nitride layer. As examples of the inorganic material, silica, alumina, AlON, SiAlON, SiNₓ (1≦x≦2) , SiOₓN_{y} (preferably 0.1≦x≦1.0 and 0.1≦y≦1), and the like can be given.

As the organic material, a silicone gel, fluorohydrocarbon liquid, acrylic resin, epoxy resin, silicone resin, or the like may be used.

The transparent medium may be formed of an inorganic material using a sputtering method, a CVD method, a sol-gel method, or the like. A transparent medium may be formed of an organic material using a spin coating method, a printing method, a dripwise injection method, or the like.

The thickness of the transparent medium is preferably 0.01 pm to 10 mm, and more preferably 0.1 μm to 1 mm.

Each member constituting the color conversion member of the invention is described below.

### [Color Conversion Medium]

### (1) Luminescent Particles

The luminescent particles used in the invention are formed of an inorganic nanocrystal obtained by finely dividing an inorganic crystal to have a particle diameter in the order of nanometers. As the inorganic nanocrystal, an inorganic nanocrystal which absorbs visible and/or near ultraviolet light and emits visible fluorescence is used. For a higher transparency and a reduced scattering loss, it is preferable to use an inorganic nanocrystal with a particle diameter of 20 nm or less, and more preferably 10 nm or less.

When the transparent medium described later is formed of a resin, the surface of the inorganic nanocrystal is preferably treated to be compatible with the resin to improve the dispersibility of the inorganic nanocrystal in the resin. As examples of the compatibilizing treatment, a method of modifying or coating the surface of the nanocrystal with a long-chain alkyl group, phosphoric acid, a resin, or the like can be given.

Specific examples of a nanocrytal used in the invention are as follows.

(1-a) Fluorescent Nanocrystal Produced by Doping Transition Metal Ion to Metal Oxide

Fluorescent nanocrystals produced by doping a transition metal ion such as Eu²⁺, Eu³⁺, Ce³⁺, or Tb³⁺ to a metal oxide such as Y₂O₃, Gd₂O₃, ZnO, Y₃Al₅O₁₂, or Zn₂SiO₄ can be given

(1-b) Fluorescent Nanocrystal Produced by Doping Transition Metal Ion to Metal Chalcogenide

Fluorescent nanocrystals produced by doping a transition metal ion which absorbs visible light such as Eu²⁺, Eu³⁺, Ce³⁺, or Tb³⁺ to a metal chalcogenide such as ZnS, CdS, or CdSe can be given. In order to prevent S, Se, or the like from being removed by a reaction component of the matrix resin described later, the surface may be modified with a metal oxide such as silica or an organic substance, for example.

(1-c) Fluorescent Nanocrystal (Semiconductor Nanocrystal) Absorbing and Emitting Visible Light Utilizing Band Gap of Semiconductor

As examples of the semiconductor nanocrystal, crystals formed of group IV element compounds (group of the periodic table (long period); hereinafter the same), group IIa element-group VIb element compounds, group IIIa element-group Vb element compounds and group IIIb element-group Vb element compounds, and chalcopyrite type compounds can be given.

Specific examples thereof include crystals of Si, Ge, MgS, ZnS, MgSe, ZnSe, AlP, GaP, AlAs, GaAs, CdS, CdSe, InP, InAs, GaSb, AlSb, ZnTe, CdTe, InSb, AgAlS₂, AgAlSe₂, AgAlTe₂, AgGaS₂, AgGaSe₂, AgGaTe₂, AgInS₂, AgInSe₂, AgInTe₂, ZnSiP₂, ZnSiAs₂, ZnGeP₂, ZnGeAs₂, ZnSnP₂, ZnSnAs₂, ZnSnSb₂, CdSiP₂, CdSiAs₂, CdGeP₂, CdGeAs₂, CdSnP₂, CdSnAs₂, and mixed crystals of these elements or compounds.

Of these, Si, AlP, AlAs, AlSb, GaP, GaAs, InP, ZnSe, ZnTe, CdS, CdSe, CdTe, CuGaSe₂, CuGaTe₂, CuInS₂, CuInSe₂ and CuInTe₂ are preferable. In particular, ZnSe, ZnTe, GaAs, CdS, CdTe, InP, CuInS₂ and CuInSe₂ (direct transition semiconductors) are still more preferable from the viewpoint of high luminous efficiency.

A semiconductor nanocrystal is preferably used because an emission wavelength can be easily controlled by its particle size, it exhibits a large absorption in the blue wavelength region and near ultraviolet wavelength region, and overlap of absorption and emission is large in an emitting region.

The functions of the semiconductor nanocrystals are described below. The semiconductor material has a band gap of 0.5 to 4.0 eV at room temperature in the state of a bulk material (“bulk material” means a material which is not formed into particles), as disclosed in JP-T-2002-510866. When forming particles using the above material and reducing the diameter of the particles to a nanometer level, electrons in the semiconductor are confined in the nanocrystal. As a result, the nanocrystal exhibits a larger band gap.

In theory, the band gap increases in inverse proportion to the square of the diameter of the semiconductor particle. Therefore, the band gap can be controlled by controlling the diameter of the semiconductor particle. This semiconductor absorbs light having a wavelength shorter than the wavelength corresponding to the band gap, and emits fluorescence having a wavelength corresponding to the band gap.

The band gap of a bulk semiconductor is preferably 1.0 to 3.0 eV at 20° C. If the band gap is less than 1.0 eV, the resulting nanocrystal exhibits a fluorescence wavelength which changes to a large extent due to a change in the particle diameter, whereby the production management becomes difficult. If the band gap exceeds 3.0 eV, since the resulting nanocrystal emits only fluorescence having a wavelength shorter than that in the near ultraviolet region, it is difficult to use such a material for a color light emitting apparatus.

The semiconductor nanocrystals may be produced using a known method such as that disclosed in U.S. Pat. No. 6,501,091. U.S. Pat. No. 6,501,091 discloses a production example in which a precursor solution prepared by mixing trioctyl phosphine (TOP) with trioctyl phosphine selenide and dimethylcadmium is added to trioctyl phosphine oxide (TOPO) heated at 350° C.

The semiconductor nanocrystal mentioned above is preferably a core/shell semiconductor nanocrystal comprising a core particle made of a semiconductor nanocystal and at least one shell layer made of a second semiconductor material having a larger band gap than the band gap of the semiconductor material used for the core particle. For example, the core/shell semiconductor nanocrystal has a structure in which the surface of a core particle formed of CdSe (band gap: 1.74 eV) is coated (covered) with a shell formed of a semiconductor material having a large band gap such as ZnS (band gap: 3.8 eV). This makes it easy to exhibit confinement effects on excitons produced in the core particle. In the above specific examples of the semiconductor nanocrystal, a phenomenon tends to occur in which S, Se, or the like is removed by an active component (e.g. unreacted monomer or water) in the transparent medium (described later) to damage the crystal structure of the nanocrystal, whereby the fluorescent properties disappear. In order to prevent this phenomenon, the surface of the semiconductor nanocrystal may be modified with a metal oxide such as silica, an organic substance, or the like.

The core/shell semiconductor nanocrystal may be produced using a known method such as that disclosed in U.S. Pat. No. 6,501,091. For example, a CdSe core/ZnS shell structure may be produced by adding a precursor solution prepared by mixing TOP with diethylzinc and trimethylsilyl sulfide to a TOPO solution heated at 140° C. in which CdSe core particles are dispersed.

A Type II nanocrystal (J. Am. Chem. Soc., Vol. 125, No. 38, 2003, pages 11466 to 11467) in which carriers forming excitons are separated between the core and the shell may also be used.

A nanocrystal with a multishell structure in which two or more layers are formed on the core to improve the stability, luminance efficiency, and emission wavelength (Angewandte Chemie, Vol. 115, 2003, pages 5189 to 5193) or the like may also be used.

The above luminescent particles may be used either individually or in combination of two or more.

In the invention, inorganic luminescent particles having a fluorescence emission peak wavelength of 470 to 550 nm are particularly suitable, since satisfactory results can be obtained when used in combination with a color filter described later.

### (2) Transparent Medium

The transparent medium is a medium in which the inorganic semiconductor nanocrystals are dispersed and which holds the semiconductor nanocrystals. As the transparent medium, a transparent material such as glass or a transparent resin may be used. In particular, a resin such as a non-curable resin, heat-curable resin, or photocurable resin is suitably used from the viewpoint of processability of the fluorescent conversion medium.

As specific examples of such a resin, in the form of either an oligomer or a polymer, a melamine resin, a phenol resin, an alkyd resin, an epoxy resin, a polyurethane resin, a maleic resin, a polyamide resin, polymethyl methacrylate, polyacrylate, polycarbonate, polyvinyl alcohol, polyvinylpyrrolidone, hydroxyethylcellulose, carboxymethylcellulose, copolymers containing monomers forming these resins, and the like can be given.

A photocurable resin may be used in order to pattern the fluorescent conversion medium. As the photo-curable resin, a photo-polymerizable resin such as an acrylic acid or methacrylic acid based resin containing a reactive vinyl group, a photo-crosslinkable resin such as polyvinyl cinnamate, or the like, which resins generally contain a photo-sensitizer, may be used. A heat-curable resin may be used when the photo-sensitizer is not used.

When forming a full color display, a fluorescent conversion medium is formed in which fluorescent material layers are separately disposed in a matrix. Therefore, a photo-curable resin which allows application of photolithography is preferably used as the matrix resin (transparent medium).

These matrix resins may be used individually or in combination of two or more.

When a photo-sensitizer is not included, an emission pattern can be formed by printing such as screen printing.

### (3) Production of Color Conversion Medium

The color conversion medium is formed using a liquid dispersion prepared by mixing and dispersing the luminescent particles and the matrix resin (transparent medium) using a known method such as milling or ultrasonic dispersion. In this case, a good solvent for the matrix resin may be used. A film is formed on a supporting substrate using the resulting luminescent particle liquid dispersion by a known film formation method such as spin coating or screen printing to produce a color conversion medium.

Note that a UV absorber, dispersant, leveling agent, and the like may be added to the color conversion medium in addition to the luminescent particles and the transparent medium insofar as the object of the invention is not impaired.

### [Color Filter]

The color filter adjusts the color of emission light to a desired color. In addition, the color filter prevents a decrease in contrast ratio of the apparatus, which decrease is caused when the color conversion medium emits fluorescence by receiving light from the outside, e.g., sunlight and room lighting or when incident light is reflected on a reflective electrode to the outside. The contrast ratio is a brightness ratio of the emitting state to the non-emitting state of the apparatus.

Examples of materials for the color filter used in the invention include the following dyes only or solid objects in which a dye is dissolved or dispersed in a binder resin.
Red (R) dye: perylene pigment, lake pigment, and azo pigment,
Green (G) dye: halogen-multisubstituted phthalocyanine pigment, halogen-multisubstituted copper phthalocyanine pigment, and basic triphenylmethane dye
Blue (B) dye: copper phthalocyanine pigment, indanthrone pigment, indophenol pigment, and cyanine pigment.

The material for the binder resin is preferably transparent (transmittance of visible light: 50% or more). Examples of the binder resin include transparent resins (polymers) such as polymethyl methacrylate, polyacrylate, polycarbonate, polyvinyl alcohol, polyvinyl pyrrolidone, hydroxyethylcellulose, and carboxymethylcellulose, and photocurable resist materials having reactive vinyl groups such as acrylic acid type, methacrylic acid type, and the like, as photosensitive resins to which photolithography can be applied. When employing printing method, a print ink (medium) using a transparent resin such as polyvinyl chloride resin, melamine resin, or phenol resin may be selected.

When the color filter is mainly made of a dye, it may be formed by a vacuum deposition method or a sputtering method using a mask having a desired color filter pattern. When it is made of a dye and a binder resin, it is generally-formed by the following method. The fluorescent dye, the above-described resin and a resist are mixed, dispersed, or dissolved. A film is formed from the mixture by spin coating, roll coating, casting, or the like. The resulting film is patterned into a desired color filter pattern by photolithography method. A color filter may be patterned into a desired color filter pattern by printing or the like.

The color filter of the invention has a transmitting band with a width of 70 nm or more, as described above. The transmitting band of the color filter may be adjusted by appropriately combining a yellow pigment (e.g. PY138 manufactured by BASF), which absorbs light on the shorter wavelength side and transmits light on the longer wavelength side, with a green pigment (e.g. PG7 manufactured by BASF) which absorbs light on both the shorter wavelength side and the longer wavelength side.

### EXAMPLES

The invention is described below in more detail by way of examples, which should not be construed as limiting the scope of the invention.

### Production Example 1

### Fabrication of Light Source (Organic EL Device)

An organic EL device with the following configuration was fabricated. The value in the parenthesis indicates the film thickness. The structure of the compound employed is given below.

Device configuration: Glass substrate (0.7 mm)/ITO (Indium tin oxide) (130 nm)/HT1 (60 nm)/HT2 (20 nm)/BH:BD ((40:2) 42 nm)/Alq (20 nm)/LiF (1 nm)/Al (150 nm)

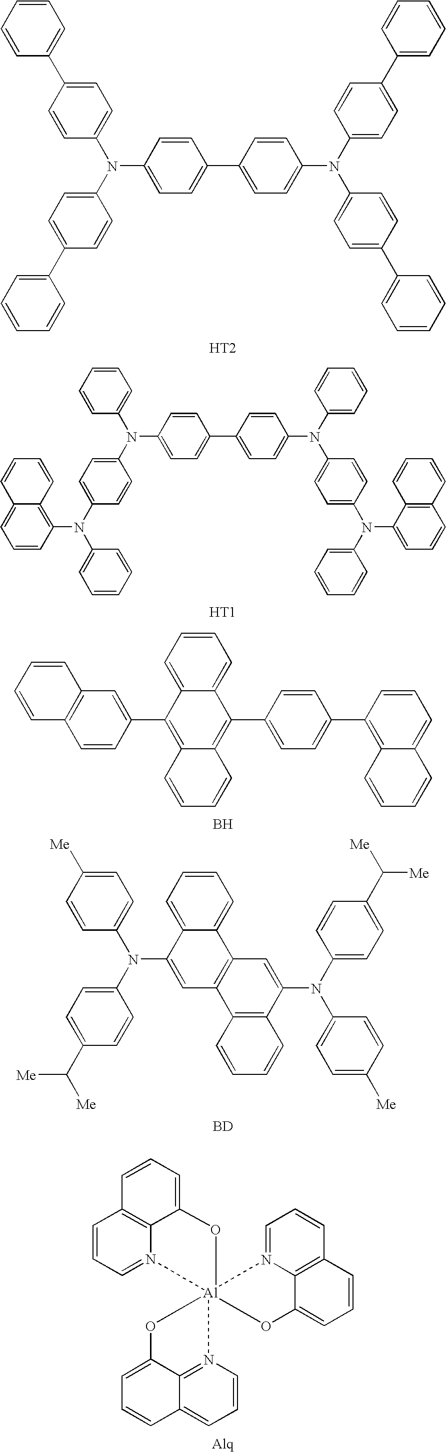

ITO was deposited by sputtering to a thickness of 130 nm on a 0.7 mm thick glass substrate. The substrate was subjected to ultrasonic cleaning for five minutes in isopropyl alcohol, and then subjected to UV ozone cleaning for 30 minutes. Thereafter, the substrate with an ITO electrode was installed in a substrate holder of a vacuum deposition system.

The above materials are installed on individual molybdenum heating boards in advance.

First, an HT1 film functioning as a hole-injecting layer was deposited to a thickness of 60 nm. Following the HT1 film formation, HT2 film functioning as a hole-transporting layer was deposited to a thickness of 20 nm. Following the HT2 film formation, the compound BH and compound BD as an organic luminescent medium layer of an organic emitting layer were co-deposited to a thickness of 42 nm with a thickness ratio of 40:2. On the film, Alq was deposited to a thickness of 20 nm as an electron-transporting layer and LiF was further deposited to a thickness of 1 nm as an electron injecting layer. After that, Al was deposited to a thickness of 150 nm as a cathode to fabricate an organic EL device.

A voltage was applied to the resulting blue organic EL device to measure the current efficiency at 10 mA/cm⁻² and the color of emitted light using a spectroradiometer. The current efficiency was 7.9 cd/A, and blue light with CIE coordinates (0.135, 0.198) was obtained.

### Production Example 2

### Fabrication of Color Filter

As organic pigments for a green color filter, four types of pigments shown in Table 1 were used. Ink was prepared by dissolving these pigments in an acrylic negative-type photoresist (“V259PA” manufactured by Nippon Steel Chemical Co., Ltd., solid content:50%). The ink was applied to a glass substrate by spin coating and exposed to ultraviolet rays. The applied ink was then developed with a 2% sodium carbonate aqueous solution and baked at 200° C. to form a green conversion film pattern (thickness:1.5 μm). The amount of the organic pigment in the ink was changed to prepare four types of color filters (CF1 to CF4) shown in Table 1.

Table 1 shows the amount of the pigment, the film thickness, the width of the transmitting band where the color filter has a transmittance of 50% or more, and the wavelength on the shorter wavelength side where the color filter has a transmittance of 50%.

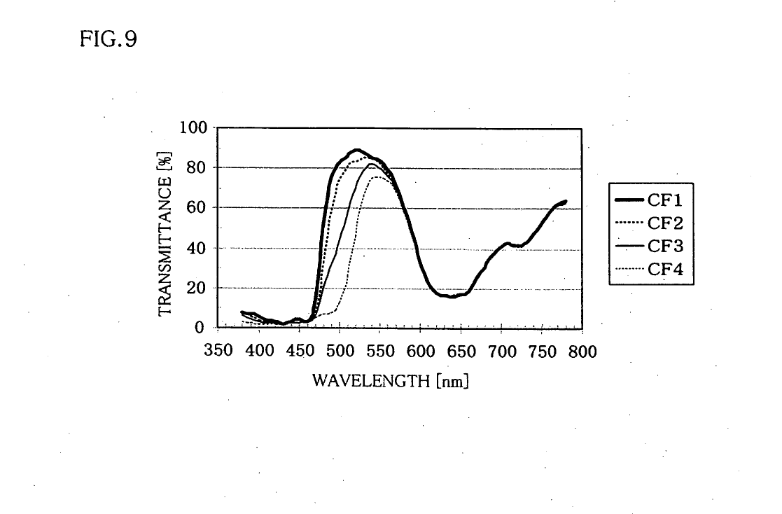

The transmitting band and the width thereof were determined by measuring the transmittance spectrum of the color filter using an ultraviolet-visible spectrophotometer. FIG. 9 shows the transmittance spectrum of each color filter.

TABLE 1

| | | | | | | | Edge on shorter |
|---|---|---|---|---|---|---|---|
| | Pigment concentration | | | | | Width of | wavelength side |
| | in film | | | | Film | transmitting | of transmitting |
| Color | (wt %) | | | | thickness | band | band |
| filter | PG7 | PY138 | PY150 | PY139 | [μm] | [nm] | [nm] |
| CF1 | 10 | 18 | — | — | 1.5 | 107 | 480 |
| CF2 | 10 | — | 18 | — | 1.5 | 100 | 486 |
| CF3 | 10 | — | 13 | 57 | 1.5 | 83 | 504 |
| CF4 | 10 | — | — | 18 | 1.5 | 62 | 522 |

PG7: Organic pigment manufactured by BASF
PY138: Organic pigment manufactured by BASF
PY150: Organic pigment manufactured by Lanxess Corporation
PY139: Organic pigment manufactured by Clariant Corporation

### Example 1

The following materials were used as the materials for the color conversion medium.

(a) Luminescent Particles

As the luminescent particles, a core/shell type semiconductor nanocrystal in which a ZnS shell was provided over a CdSe core (diameter: 3.9 nm) was used. The fluorescence peak wavelength was 525 nm, and the FWHM was 30 nm.

(b) Transparent medium solution for dispersing and retaining luminescent particles

As the transparent medium, a copolymer of methacrylic acid and methyl methacrylate (copolymerization ratio of methacrylic acid=15 to 20%, Mw=20,000 to 25,000, refractive index=1.60) was used. The copolymer was dissolved in 1-methoxy-2-acetoxypropane to obtain a transparent medium solution.

### (1) Fabrication of Color Conversion Substrate

The luminescent particles were added to the transparent medium solution such that the solid content in the film was 5.0×10⁻³ mol/l, and dispersed in the solution.

The dispersion was applied on the color filter film of the green color filter substrate (CF1) fabricated in Production Example 2 by spin coating, and dried at 200° C. for 30 minutes to form a color conversion medium with a thickness of 20 μm, whereby a color conversion substrate (CCM1) was obtained.

For the purpose of evaluation, a color conversion medium was formed on a glass substrate in the same manner as in the formation of the color conversion substrate. The absorption spectrum of the color conversion medium was measured using an ultraviolet-visible spectrophotometer.

### (2) Evaluation

An emitting apparatus was formed by attaching, through a silicone oil with a refractive index of 1.53, the organic EL device fabricated in Production Example 1 and the color conversion substrate fabricated in (1) above so that the glass substrate side (light-outcoupling side) of the organic EL device faced to the color conversion medium layer of the color conversion substrate.

The luminance of light from the color conversion substrate (luminance A [nit]) was measured under conditions where the organic EL device emits light at a luminance of 150 [nit].

The luminance of reflected light from the color conversion substrate (luminance B [nit]) was measured under a fluorescent lamp (500 lx) with the organic EL device being in a non-operating state. The contrast ratio was determined from the ratio of the luminance A to the luminance B (A/B).

The luminance when the organic EL device was in an operating state was 218 nits, and the luminance when the organic EL device was in a non-operating state (under fluorescent lamp) was 0.59 nits. The contrast ratio was as high as 370. The absorbance of the color conversion medium at the wavelength (480 nm) at the edge on the shorter wavelength side where the color filter (CF1) had a transmittance of 50% was 0.571.

The configurations and the evaluation results of the color conversion substrates fabricated in Example 1 and each example described later are shown in Table 2.

TABLE 2

| | Color filter | | | Color conversion medium | | | |
|---|---|---|---|---|---|---|---|
| | | | Edge on shorter | | Absorbance | | |
| | | Width of | wavelength side | Color | of | Display performance | |
| | | transmitting | of transmitting | conversion | color conversion | | Contrast |
| | Color filter | band | band | medium used | medium | Luminance A | ratio |
| | used | [nm] | [nm] | [nm] | [—] | [nit] | [—] |
| Example 1 | CF1 | 107 | 480 | CCM1 | 0.57 | 218 | 370 |
| Example 2 | CF2 | 100 | 486 | CCM1 | 0.67 | 210 | 370 |
| Example 3 | CF3 | 83 | 503 | CCM1 | 1.07 | 198 | 350 |
| Comparative | CF4 | 62 | 522 | CCM1 | 0.73 | 172 | 300 |
| Example 1 | | | | | | | |
| Comparative | CF2 | 100 | 486 | CCM2 | 2.68 | 100 | 210 |
| Example 2 | | | | | | | |
| Comparative | CF2 | 100 | 486 | CCM3 | 0.04 | 122 | 190 |
| Example 3 | | | | | | | |

The luminance A indicates the luminance of light from the color conversion medium when the organic EL device emits light at a luminance of 150 nits.

### Example 2

A color conversion substrate was fabricated and evaluated in the same manner as in Example 1, except that the color filter CF2 was used instead of the color filter CF1.

The luminance when the organic EL device was in an operating state was 210 nits, and the luminance when the organic EL device was in a non-operating state was 0.57 nits. The contrast ratio was as high as 370. The absorbance of the color conversion medium at the wavelength (486 nm) at the edge on the shorter wavelength side where the color filter (CF2) had a transmittance of 50% was 0.670.

### Example 3

A color conversion substrate was fabricated and evaluated in the same manner as in Example 1, except that the color filter CF3 was used instead of the color filter CF1.

The luminance when the organic EL device was in an operating state was 198 nits and the luminance when the organic EL device was in a non-operating state was 0.57 nits. A satisfactory contrast ratio of 350, though slightly lower than those obtained in Examples 1 and 2, was obtained. The absorbance of the color conversion medium at the wavelength (503 nm) at the edge on the shorter wavelength side where the color filter (CF3) had a transmittance of 50% was 1.07.

### Comparative Example 1

A color conversion substrate was fabricated and evaluated. in the same manner as in Example 1, except that the color filter CF4 was used instead of the color filter CF1.

The luminance when the organic EL device was in an operating state was lowered to 172 nits, and the luminance when the organic EL device was in a non-operating state was 0.57 nits. The contrast ratio was lowered to 300. The absorbance of the color conversion medium at the wavelength (522 nm) at the edge on the shorter wavelength side where the color filter (CF4) had a transmittance of 50% was 0.728.

### Comparative Example 2

### (1) Fabrication of Color Conversion Substrate

The luminescent particles were added to the transparent medium solution such that the solid content in the film was 1.0×10⁻² mol/l, and dispersed in the solution.

The resulting dispersion was applied on the color filter film of the green color filter substrate (CF2) fabricated in Production Example 2by spin coating, and dried at 200° C. for 30 minutes to form a color conversion medium with a thickness of 20 μm, whereby a color conversion substrate (CCM2) was obtained.

For the purpose of evaluation, a color conversion medium was formed on a glass substrate in the same manner as in the formation of the color conversion substrate. The absorption spectrum of the color conversion medium was measured using an ultraviolet-visible spectrophotometer.

### (2) Evaluation

An emitting apparatus was formed and evaluated in the same manner as in Example 1.

The luminance when the organic EL device was in an operating state was lowered to 100 nits, and the luminance when the organic EL device was in a non-operating state was 0.48 nits. The contrast ratio was lowered to 210. The absorbance of the color conversion medium at the wavelength (486 nm) at the edge on the shorter wavelength side where the color filter (CF2) had a transmittance of 50% was 2.68.

### Comparative Example 3

A color conversion substrate (CCM3) was fabricated and evaluated in the same manner as in Comparative Example 2, except that the luminescent particles were added to the transparent medium solution such that the solid content in the film was 5.0×10⁻⁴ mol/l, and dispersed in the solution.

The luminance when the organic EL device was in an operating state was lowered to 122 nits, and the luminance when the organic EL device was in a non-operating state was 0.64 nits. The contrast ratio was lowered to 190. The absorbance of the color conversion medium at the wavelength (486 nm) at the edge on the shorter wavelength side of the color filter (CF2) at which the color filter had a transmittance of 50% was 0.04.

### INDUSTRIAL APPLICABILITY

The color conversion substrate of the invention may be suitably used as a member which forms an emitting apparatus in combination with various light sources such as an organic EL device and a light-emitting diode. In particular, the color conversion substrate of the invention is suitable as a color conversion substrate for organic EL devices.

What is claimed is:

1. A color conversion substrate comprising:
a color conversion medium comprising at least inorganic-luminescent-nanocrystal particles; and
a color filter having a transmitting band with a width of 70 nm or more where the color filter has a transmittance of 0.5 or more, the color filter being formed on one side of the color conversion medium;
the absorbance of the color conversion medium being 0.1 or more and 2 or less at the wavelength of the transmitting band edge on the shorter wavelength side of the color filter where the color filter has a transmittance of 0.5.

2. The color conversion substrate according to claim 1 wherein the color conversion medium comprises a transparent medium and the inorganic-luminescent-nanocrystal particles dispersed in the transparent medium.

3. The color conversion substrate according to claim 1 wherein the inorganic-luminescent-nanocrystal particles are a semiconductor nanocrystal.

4. The color conversion substrate according to claim 1 wherein the width of the transmitting band of the color filter is 70 nm or more and 120 nm or less.

5. The color conversion substrate according to claim 1 wherein the width of the transmitting band of the color filter is 80 nm or more and 110 nm or less.

6. The color conversion substrate according to claim 1 that is a green color conversion substrate having an emission peak wavelength in the range from 470 to 550 nm.

7. A color converting substrate wherein at least one color pixel comprises the color conversion substrate of claim 1.
